(19) United States
(12) Patent Application Publication
(10) Pub. No.: US 2025/0209509 A1
(43) Pub. Date: Jun. 26, 2025

(54) PRODUCT SEARCH DEVICE, PRODUCT SEARCH METHOD, AND RECORDING MEDIUM

(71) Applicant: NEC Corporation, Minato-ku, Tokyo (JP)

(72) Inventor: Takahiro Nakagawa, Tokyo (JP)

(73) Assignee: NEC Corporation, Minato-ku, Tokyo (JP)

(21) Appl. No.: 18/847,814

(22) PCT Filed: Mar. 28, 2022
(86) PCT No.: PCT/JP2022/014860

§ 371 Date: Sep. 17, 2024

(51) Int. Cl. G06Q 30/0601; G06F 3/01

(52) U.S. Cl. CPC G06Q 30/0623; G06F 3/013; G06Q 30/0631

(57) ABSTRACT

The acquisition means acquires an image of products and user's gaze information for a product shelf on which the products are displayed. The recognition means recognizes a product based on the image and the user's gaze information. The information output means acquires information of a recognized product and outputs the information.

### TECHNICAL FIELD

The present disclosure relates to technique of retrieving image-taken product.

### BACKGROUND ART

In a physical store, customers need to pick up a product when they want to check information of the product displayed on a product shelf. However, there is a need to confirm information of the product without touching them as much as possible from the viewpoint of hygiene, etc. For example, Patent Document 1 describes a shopping system which specifies the product that customers are gazing at and performs a purchase processing.

### PRECEDING TECHNICAL REFERENCES

### Patent Document

Patent Document 1: Japanese Patent Application Laid-Open under No. JP2012-8746

### SUMMARY

### Problem to be Solved

However, even by Patent Document 1, it is not always possible to efficiently look at the information of product.

It is an object of the present disclosure to provide a product search device that enables to confirm the information of product without touching the product.

### Means for Solving the Problem

According to an example aspect of the present disclosure, there is provided a product search device comprising:
an acquisition means configured to acquire an image of products and user's gaze information for a product shelf on which the products are displayed;
a recognition means configured to recognize a product based on the image and the user's gaze information; and
an information output means configured to acquire information of a recognized product and output the information.

According to another example aspect of the present disclosure, there is provided a product search method comprising:
acquiring an image of products and user's gaze information for a product shelf on which the products are displayed;
recognizing a product based on the image and the user's gaze information; and
acquiring information of a recognized product and outputting the information.

According to still another example aspect of the present disclosure, there is provided a recording medium storing a program, the program causing a computer to execute processing of:
acquiring an image of products and user's gaze information for a product shelf on which the products are displayed;
recognizing a product based on the image and the user's gaze information; and
acquiring information of a recognized product and outputting the information.

### Effect

According to the present disclosure, it is possible for customers to confirm the information of product without touching the product.

### BRIEF DESCRIPTION OF THE DRAWINGS

FIG. 1 shows an overall configuration of a product search system according to a first example embodiment.

FIGS. 2A and 2B are block diagrams showing a configuration of a server and a user terminal.

FIG. 3 is a block diagram showing a functional configuration of a server.

FIG. 4 is an example of data structure of product information.

FIG. 5 is an example of data structure of user information.

FIG. 6 shows a display example of product information.

FIG. 7 is a flowchart of product search system.

FIG. 8 shows a display example of a modification 1 of a first example embodiment.

FIG. 9 is a block diagram showing a functional configuration of a product search device of the second example embodiment.

FIG. 10 is a flowchart of processing by the product search device of the second example embodiment.

### EXAMPLE EMBODIMENTS

### First Example Embodiment

### [Overall Configuration]

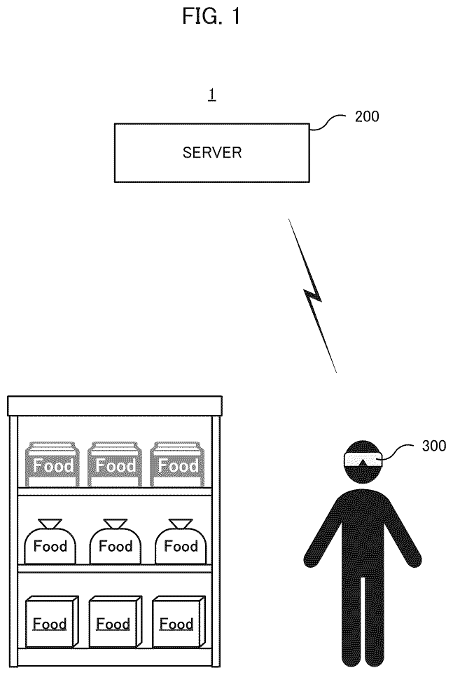

FIG. 1 shows an overall configuration of a product search system to which a product search device according to the present disclosure is applied. A product search system 1 includes a server 200 and a user terminal 300. The server 200 is an example of the product search device. The user terminal 300 is a terminal device such as smart grasses owned by a user. Further, the server 200 and the user terminal 300 can communicate wirelessly. Instead of smart glasses, other glasses-type wearable terminals such as AR (Augmented Reality) glasses, MR (Mixed Reality) glasses, and VR (Virtual Reality glasses) may be used.

As a basic operation, the server 200 recognizes the product based on video transmitted from the user terminal 300, and acquires detailed information related to the product (hereinafter referred to as “product information”). Then, the server 200 transmits product information to the user terminal 300. Specifically, the user enters a store while wearing the user terminal 300. Then, the user makes a predetermined utterance such as “Check this” while looking at product displayed in the store. When the user terminal 300 recognizes the predetermined utterance of the user, the user terminal 300 activates a camera and takes a moving image of user's vision including the product. In addition, when the user terminal 300 recognizes the predetermined utterance of the user, the user terminal 300 performs gaze measurement and acquires the gaze information of the user. The user terminal 300 transmits the taken moving image (hereinafter also referred to as a “taken video”) and the gaze information of the user to the server 200. The server 200 extracts an image of the product desired to be searched by the user based on the taken video and the gaze information of the user. The server 200 recognizes what product is taken from the product images by image analysis of AI (Artificial Intelligence) or the like. The server 200 acquires the product information of the recognized product, and transmits the acquired product information to the user terminal 300.

In the above description, the store is assumed a physical store, instead, the store may be an online store. In this case, the user displays an online store screen on the user terminal 300. Then, the user makes a predetermined utterance such as “Check this” while looking at a product of the online store. When the user terminal 300 recognizes the predetermined utterance of the user, the user terminal 300 transmits the online store screen and the gaze information of the user to the server 200. The server 200 extracts an image of the product desired to be searched by the user based on the online store screen and the gaze information of the user, and recognizes what product is taken from the product images. The server 200 acquires the product information of the recognized product, and transmits the acquired product information to the user terminal 300.

### [Server]

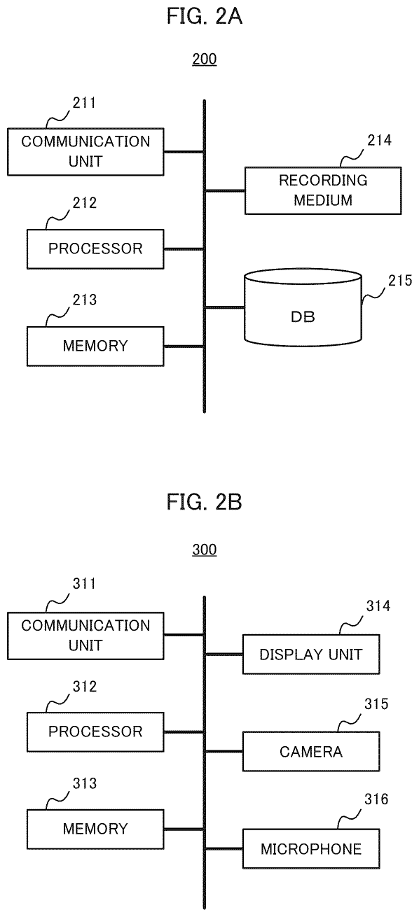

FIG. 2A is a block diagram showing a configuration of the server 200. The server 200 mainly includes a communication unit 211, a processor 212, a memory 213, a recording medium 214, and a data base (hereinafter referred to as “DB”) 215.

The communication unit 211 transmits and receives data with an external device. Specifically, the communication unit 211 transmits and receives information with the user terminal 300.

The processor 212 is a computer such as a CPU (Central Processing Unit). The processor 212 controls the entire server 200 by executing a program prepared in advance. The processor 212 may be a GPU (Graphics Processing Unit), a FPGA (Field-Programmable Gate Array), a DSP (Demand-Side Platform), a ASIC (Application Specific Integrated Circuit), or the like.

The memory 213 is configured by a ROM (Read Only Memory) and a RAM (Random Access Memory), and the like. The memory 213 is also used as a working memory during the execution of various processing by the processor 212. The memory 213 temporarily stores a series of video taken by the user terminal 300 based on the control of the processor 212. The taken video is stored in the memory 213 in association with, for example, user identification information (hereinafter also referred to as “user ID”) and time stamp information, etc.

The recording medium 214 is a non-volatile and non-temporary recording medium such as a disk-type recording medium, a semiconductor memory, or the like, and is configured to be detachable from the server 200. The recording medium 214 records various programs executed by the processor 212.

The DB 215 stores the product information and information related to a user (hereinafter also referred to as “user information”). The DB 215 may include an external storage device, such as a hard disk connected to or incorporated in the servers 200, and may include a storage medium, such as a removable flash memory. Instead of providing the DB 215 in the server 200, the DB 215 may be provided in an external server or the like to store the product information or the user information to the server through communication.

The server 200 may include a keyboard, an input unit such as a mouse, and a display unit such as a liquid crystal display for an administrator's instruction and input.

### [User Terminal]

FIG. 2B is a block diagram showing a configuration of the user terminal 300. The user terminal 300 is, for example, a terminal device such as smart glasses. The user terminal 300 includes a communication unit 311, a processor 312, a memory 313, a display unit 314, a camera 315, and a microphone 316.

The communication unit 311 transmits and receives data with an external device. Specifically, the communication unit 311 transmits and receives information with the server 200.

The processor 312 is a computer such as a CPU. The processor 312 controls the entire user terminal 300 by executing a program prepared in advance. The processor 312 may be a GPU, FPGA, DSP, ASIC or the like. The processor 312 transmits the moving image taken by the camera 315 to the server 200 by executing a program prepared in advance.

The memory 313 is configured by a ROM and a RAM. The memory 313 stores various programs executed by the processor 312. The memory 313 is also used as a working memory during the execution of various processing by the processor 312. The moving image taken by the camera 315 is stored in the memory 313 and then transmitted to the server 200. The display unit 314 is, for example, a liquid crystal display device and displays the video taken by the camera 315 or the product information transmitted from the server 200.

The camera 315 includes a camera that captures the user's filed of vision (also referred to as “out-camera”) and a camera that captures the user's eyeballs (also referred to as “eye-camera”). The out-camera is mounted outside the user terminal 300. The out-camera captures the user's field of vision including a subject and transmits the image to the server 200. Thus, the server 200 can acquire the image of the subject. The eye-camera is mounted inside the user terminal 300 to capture the user's eyeballs. The eye-camera captures the user's eyeballs and transmits the image to the processor 312. The processor 312 detects the movement of the user's line of sight or the like based on the image of the user's eyeballs taken by the eye-camera. Thus, the user terminal 300 can acquire the gaze information such as the user's gaze direction. The microphone 316 collects the voice of the user and the surrounding sound, and transmits it to the server 200.

### [Function Configuration]

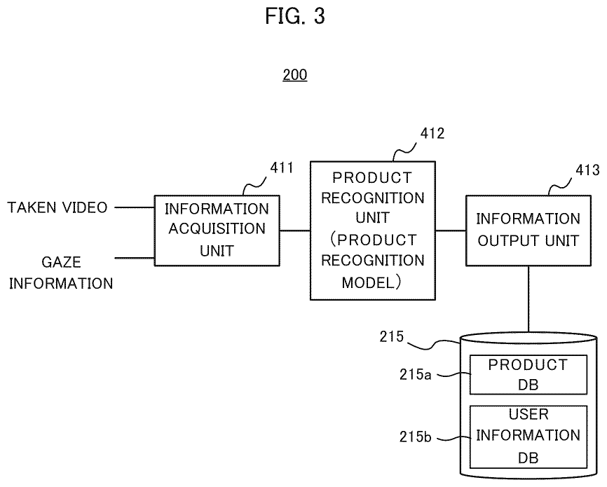

FIG. 3 is a block diagram showing a functional configuration of the server 200. The server 200 functionally includes an information acquisition unit 411, a product recognition unit 412, and an information output unit 413.

The server 200 receives the taken video and the user's gaze information from the user terminal 300. The taken video and the user's gaze information are input to the information acquisition unit 411. Note that the user's gaze information includes information such as the area of the taken video at which the user was looking and the time when the user was looking at the area, or the like.

The information acquisition unit 411 extracts an image of product to be searched by the user (hereinafter, also referred to as “target product”), based on the taken video and the user's gaze information. Then, the information acquisition unit 411 outputs the image of the target product to the product recognition unit 412. Specifically, the taken video input from the user terminal 300 is a video that captures the user's vision. Therefore, the taken video may include products other than the target product. Therefore, the information acquisition unit 411 detects the products included in the taken video by using an image recognition model prepared in advance. The information acquisition unit 411 estimates the target product based on the detected products and the user's gaze information. For example, the information acquisition unit 411 estimates the product located in the area that the user has looked at for the longest time from among the detected products as the target product. The information acquisition unit 411 extracts the area in which the target product is taken from the taken video, and generates the image of the target product. The information acquisition unit 411 outputs the image of the target product to the product recognition unit 412.

In addition, the information acquisition unit 411 extracts the user ID associated with the taken video. The information acquisition unit 411 outputs the extracted user ID to the product recognition unit 412.

The product recognition unit 412 acquires the image of the target product and the user ID from the information acquisition unit 411. The product recognition unit 412 recognizes the target product from the image of the target product using an image recognition model prepared in advance. Then, the product recognition unit 412 outputs product identification information of the target product as the recognition result of the target product. Note that the product identification information is an ID for uniquely identifying a product and is also referred to as the “product ID” hereafter. The image recognition model used by the product recognition unit 412 is a machine learning model that is learned in advance so as to estimate a product included in the image, and is also hereinafter referred to as the “product recognition model”. The product recognition unit 412 outputs the product ID and the user ID to the information output unit 413.

The information output unit 413 acquires the product information of the target product from the product DB 215a, based on the product ID acquired from the product recognition unit 412. The information output unit 413 acquires the user information from the user information DB 215b, based on the user ID acquired from the product recognition unit 412. The information output unit 413 acquires the product information of the target product from the product DB 215a, but instead, may acquire the product information of the target product from the Internet. In this case, the product recognition unit 412 outputs the product name or the like as the product identification information to the information output unit 413.

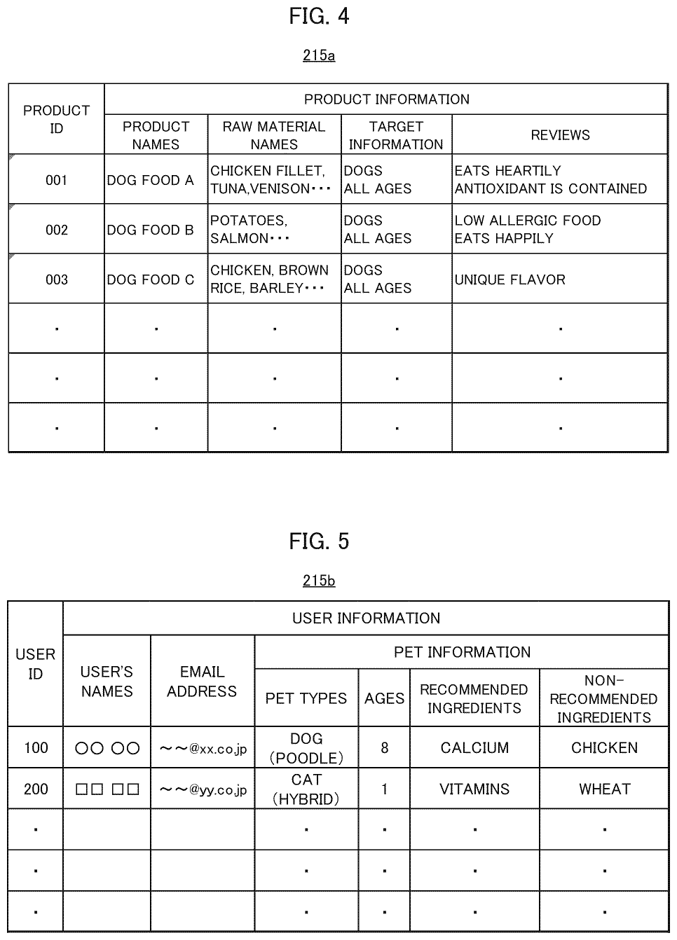

Here, the product information and the user information will be described with an example. FIG. 4 shows an example of data structure of the product information. In this case, the product ID is associated with the product information, and is stored in the product DB 215a. The product ID is an ID for uniquely identifying a product. The product information is detailed information on the product, and includes product names, raw material names, target information, reviews, etc. Note that the target information is information such as animals to be the target of the product and ages to be the target of the product. Further, the product information may include information such as manufacturer names, prices, places of origin, capacity, usage, and effects in addition to the above.

FIG. 5 shows an example of data structure of user information. In this case, the user ID is associated with the user information, and is stored in the user information DB 215b. The user ID is an ID for uniquely identifying a user. The user information is information about users, including the user's names, the user's email address and the like. Further, in FIG. 5, the user information includes information about a pet which the user is rearing (hereinafter, also referred to as “pet information”). The pet information includes pet types, ages of pet, and ingredients affecting pet health. The ingredients affecting pet health include recommended ingredients for the pets and non-recommended ingredients for the pets. The recommended ingredients for the pets are useful ingredients for pet health, such as foods and nutrients that the users want user's pets to actively consume. The non-recommended ingredients for the pets are harmful ingredients for pet health, such as foods that causes allergies.

The information output unit 413 compares the acquired product information with the user information. The information output unit 413 generates the product information highlighting the matched part, when the product information matches with the user information. For example, the information output unit 413 compares the raw material included in the raw material name of the product information with the recommended or non-recommended ingredients of the pet information. Then, when the raw material and the recommended ingredients or the non-recommended ingredients match, the information output unit 413 generates the product information highlighting the matched raw material. The information output unit 413 outputs the product information to the user terminal 300.

### [Display Example]

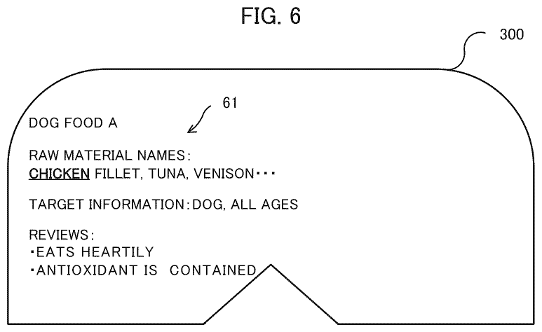

Next, a display example of the product information transmitted by the server 200 is shown. FIG. 6 shows a display example of the product information. In the example of FIG. 6, the product information transmitted from the server 200 is displayed on the user terminal 300. In this example, it is assumed that the target product is “dog food A”. In addition, it is assumed that “chicken” is registered as a non-recommended ingredient of pets in the user information. Specifically, in FIG. 6, the product information 61 is displayed on the user terminal 300. The product information 61 is the product information of the target product. The product information 61 includes the product name, the raw material names, the target information, and the reviews as the product information. In addition, the raw material names of the target product include “chicken” which is the non-recommended ingredient of the pets, and the “chicken” part of the raw material name is highlighted by the thick line and the underline. Thus, by highlighting the non-recommended ingredients of the pets, the user can easily refer to the non-recommended ingredients of the pets from the product information.

The target product is not limited to foods for the pets, but may be foods for humans. When the target product is a human food, the user registers personal information of the user himself/herself and the user's family as the user information in advance. The personal information includes, for example, age, recommended ingredients, non-recommended ingredients, favorite foods, and disliked foods of the person. The information output unit 413 compares the product information of the target product with the personal information, and outputs the product information highlighting the matched part to the user terminal 300. Thus, the user can easily grasp whether or not the target product is a food suitable for the person registered in the user information.

### [Product Recognition Model]

Next, a product recognition model used by the product recognition unit 412 will be described. The product recognition model is a model which estimates the product ID of the product included in the images, and is generated by so-called supervised learning. In order to learn the product recognition model, images of each product sold in a store to which a label of the product ID is given as training data is used. A machine learning device learns the relation between the image of the product and the product ID using the training data. Then the product recognition model is generated.

The product recognition unit 412 estimates the product ID of the target product using the generated product recognition model. Specifically, the product recognition model outputs a probability indicating which the product ID the target product belongs to, based on the input images of the target product. For example, for a target product, the product recognition model outputs a probability that the product ID is 001 as “0.7”, a probability that the product ID is 002 as “0.2”, and a probability that the product ID is 003 as “0.1”. The product recognition model outputs the probability so that the sum of the probability of each the product ID becomes “1”. Then, the product recognition model estimates the product ID with the highest probability as the product ID of the target product. In the above-described case, the product recognition model outputs an estimation result that “the product ID is 001”.

### [Product Search Processing]

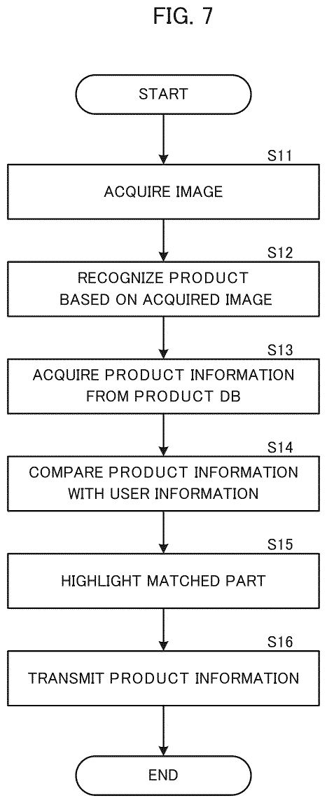

Next, product search processing for performing the above-mentioned product search will be described. FIG. 7 is a flowchart of product search processing by the server 200. This processing is realized by the processor 212 shown in FIG. 2, executing a pre-prepared program and operating as each element shown in FIG. 3.

First, the user wearing the user terminal 300 makes the predetermined utterance such as “Check this” while looking at product displayed in the store. When the user terminal 300 recognizes the predetermined utterance of the user, the user terminal 300 starts taking a video. Further, when the user terminal 300 recognizes the predetermined utterance of the user, the user terminal 300 acquires the user's gaze information. Then, the user terminal 300 transmits the taken video and the gaze information to the server 200.

The information acquisition unit 411 of the server 200 acquires the taken video and the user's gaze information from the user terminal 300. The information acquisition unit 411 estimates the target product based on the taken video and the user's gaze information. Then, the information acquisition unit 411 acquires the image of the target product from the taken video (step S11). The information acquisition unit 411 acquires the user ID associated with the taken video. The information acquisition unit 411 outputs the image of the acquired target product and the user ID to the product recognition unit 412. Next, the product recognition unit 412 recognizes the product based on the image of the target product acquired from the information acquisition unit 411 using the previously learned product recognition model, and outputs the product ID as the recognition result (step S12). The product recognition unit 412 outputs the user ID acquired from the information acquisition unit 411 and the product ID to the information output unit 413.

Next, the information output unit 413 acquires the product information of the target product from the product DB 215a based on the product ID acquired from the product recognition unit 412 (step S13). The information output unit 413 may acquire the product information of the target product from the Internet. The information output unit 413 acquires the user information from the user information DB 215b based on the user ID acquired from the product recognition unit 412. Then, the information output unit 413 compares the product information with the user information (step S14). As a result of comparing the product information with the user information, when there is a matched part, the information output unit 413 generates the product information highlighting the matched part (step S15). For example, when “chicken” is included in the raw material names of the product information and “chicken” is registered as the recommended ingredient or the non-recommended ingredient in the user information, the information output unit 413 generates the product information highlighting the “chicken” part of the raw material names. The information output unit 413 transmits the product information to the user terminal 300 (step S16). Then, the product search processing ends.

### Modification

Next, a modification of the first example embodiment will be described. The following modification can be applied to the first example embodiment.

### (Modification 1)

In the first example embodiment described above, the server 200 outputs the product information of the target product to the user terminal 300. In addition to the above, the server 200 may output the product information of the recommended products to the user terminal 300. The recommended products are alternatives to target product, such as products that contain recommended ingredients or products that do not contain non-recommended ingredients. Specifically, the server 200 acquires the product information of the product not including the non-recommended ingredients from the product DB 215a or the Internet, when the product information of the target product includes the non-recommended ingredients. Then, the server 200 outputs the product that does not include the non-recommended ingredients as the recommended product to the user terminal 300. On the other hand, when the product information of the target product does not include the non-recommended ingredients of the pets, the server 200 acquires the product information of the product including the recommended ingredients of the pets or the other product not including the non-recommended ingredients of the pets from the product DB 215a or the Internet, and outputs the acquired product as the recommended product to the user terminal 300.

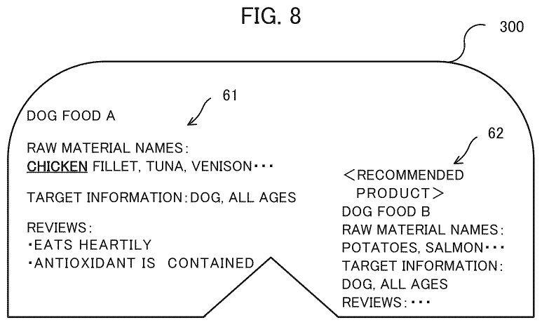

FIG. 8 shows a display example of the modification 1. In the display example of the modification 1, in addition to the product information 61, the recommended product 62 is displayed on the user terminal 300. The product information 61 is the same as the product information 61 shown in FIG. 6. The product information 61 includes “chicken” which is the non-recommended ingredients of the pets. The recommended product 62 is the product information of the recommended product. In the recommended product 62, the product information of the product not containing “chicken” which is the non-recommended ingredient of the pets is displayed as the recommended product. Thus, the user can grasp the alternative product of the target product.

### (Modification 2)

In the first example embodiment, the server 200 transmits the product information of the target product to the user terminal 300, based on a predetermined utterance by the user. Instead, the server 200 may select the recommended product from the products included in the taken video and transmit the product information of the recommended products to the user terminal 300. Specifically, in the physical store, the user moves in the store while taking the video by the user terminal 300. At this time, the user terminal 300 transmits the taken video to the server 200 each time. When the server 200 acquires the taken video from the user terminal 300, the server 200 detects the products included in the taken video and acquires the product information of the detected products. Then, the server 200 compares the product information with the user information. When the product information includes the recommended ingredients or when the product information does not include the non-recommended ingredients, the server 200 determines the product as the recommended product. The server 200 transmits the product information of the recommended product to the user terminal 300. Thus, the user can grasp the recommended products from among the products in the store.

### (Modification 3)

In the first example embodiment described above, basically, information acquired by the user terminal 300 is transmitted to the server 200 as it is. Then, the server 200 recognizes the target product and acquires the product information based on the received information. Instead, the user terminal 300 may perform processing to recognize the target product and transmit the processing result to the server 200. Further, the user terminal 300 may perform processing to recognize the target product and processing to acquire the product information without using the server 200. Thus, the communication load from the user terminal 300 to the server 200 and the processing load in the server 200 can be reduced. In these cases, the user terminal 300 is an example of a product search device.

### Second Embodiment

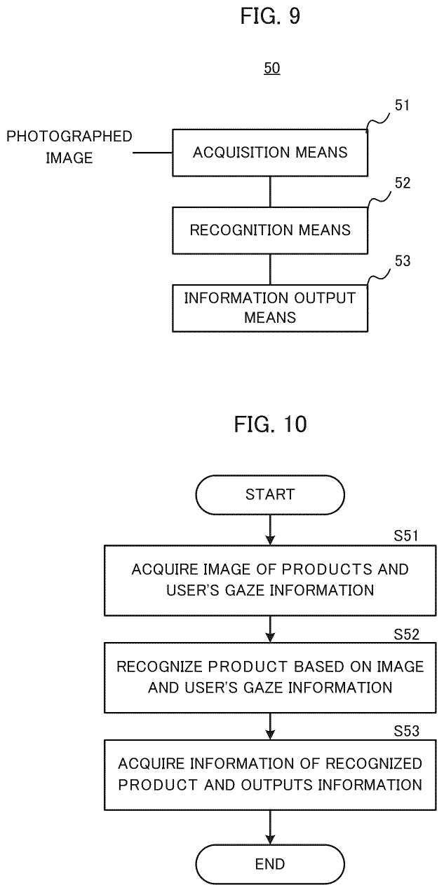

FIG. 9 is a block diagram showing a functional configuration of a product search device according to the second example embodiment. The product search device 50 of the second example embodiment includes an acquisition means 51, a recognition means 52, and an information output means 53.

FIG. 10 is a flowchart of processing by the product search device 50. The acquisition means 51 acquires an image of products and user's gaze information for a product shelf on which the products are displayed (step S51). The recognition means 52 recognizes a product based on the image and the user's gaze information (step S52). The information output means 53 acquires information of a recognized product and outputs the information (step S53).

According to the product search device 50 of the second example embodiment, it is possible for customers to confirm the information of product without touching the product.

A part or all of the example embodiments described above may also be described as the following supplementary notes, but not limited thereto.

### SUPPLEMENTARY NOTE 1

A product search device comprising:
an acquisition means configured to acquire an image of products and user's gaze information for a product shelf on which the products are displayed;
a recognition means configured to recognize a product based on the image and the user's gaze information; and
an information output means configured to acquire information of a recognized product and output the information.

### SUPPLEMENTARY NOTE 2

The product search device according to Supplementary note 1, wherein the information output means acquires information about ingredients affecting health of a user or health of a user's pet, outputs information of the product highlighting useful ingredients for health of the user or the user's pet among ingredients included in the product.

### SUPPLEMENTARY NOTE 3

The product search device according to Supplementary note 2, wherein the information output means outputs information of a recommended product which includes the useful ingredients and is different from the recognized product.

### SUPPLEMENTARY NOTE 4

The product search device according to Supplementary note 1, wherein the information output means acquires information about ingredients affecting health of a user or health of a user's pet, outputs information of the product highlighting harmful ingredients for health of the user or the user's pet among ingredients included in the product.

### SUPPLEMENTARY NOTE 5

The product search device according to Supplementary note 4, wherein the information output means outputs information of a recommended product which is an alternative to the recognized product and does not include the harmful ingredients for health.

### SUPPLEMENTARY NOTE 6

The product search device according to Supplementary note 3 or 5, wherein the image is an image of the products in a store,
wherein the information output means selects the recommended product from the products in the store.

### SUPPLEMENTARY NOTE 7

The product search device according to any one of Supplementary notes 1 to 6, wherein the acquisition means acquires the image of the products and the user's gaze information from a terminal device of the user, and
wherein the information output means outputs information of the product to the terminal device.

### SUPPLEMENTARY NOTE 8

A product search method comprising:
acquiring an image of products and user's gaze information for a product shelf on which the products are displayed;
recognizing a product based on the image and the user's gaze information; and
acquiring information of a recognized product and outputting the information.

### SUPPLEMENTARY NOTE 9

A recording medium storing a program, the program causing a computer to execute processing of:
acquiring an image of products and user's gaze information for a product shelf on which the products are displayed;
recognizing a product based on the image and the user's gaze information; and
acquiring information of a recognized product and outputting the information.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

200 Server
215 Database (DB)
300 User terminal
411 Information acquisition unit
412 Product recognition unit
413 Information output unit

What is claimed is:

1. A product search device comprising:
a memory configured to store instructions; and
a processor configured to execute the instructions to:
acquire an image of products and user's gaze information for a product shelf on which the products are displayed;
recognize a product based on the image and the user's gaze information; and
acquire information of a recognized product and output the information.

2. The product search device according to claim 1, wherein the processor acquires information about ingredients affecting health of a user or health of a user's pet, outputs information of the product highlighting useful ingredients for health of the user or the user's pet among ingredients included in the product.

3. The product search device according to claim 2, wherein the processor outputs information of a recommended product which includes the useful ingredients and is different from the recognized product.

4. The product search device according to claim 1, wherein the processor acquires information about ingredients affecting health of a user or health of a user's pet, outputs information of the product highlighting harmful ingredients for health of the user or the user's pet among ingredients included in the product.

5. The product search device according to claim 4, wherein the processor outputs information of a recommended product which is an alternative to the recognized product and does not include the harmful ingredients for health.

6. The product search device according to claim 3, wherein the image is an image of the products in a store,
wherein the processor selects the recommended product from the products in the store.

7. The product search device according to claim 1, wherein the processor acquires the image of the products and the user's gaze information from a terminal device of the user, and
wherein the processor outputs information of the product to the terminal device.

8. A product search method comprising:
acquiring an image of products and user's gaze information for a product shelf on which the products are displayed;
recognizing a product based on the image and the user's gaze information; and
acquiring information of a recognized product and outputting the information.

9. A non-transitory computer-readable recording medium storing a program, the program causing a computer to execute processing of:
acquiring an image of products and user's gaze information for a product shelf on which the products are displayed;
recognizing a product based on the image and the user's gaze information; and
acquiring information of a recognized product and outputting the information.
